(19) United States
(12) Patent Application Publication
(10) Pub. No.: US 2022/0050972 A1
(43) Pub. Date: Feb. 17, 2022

(54) INTELLIGENT DISCOVERY MULTI-TURN OPEN DIALOGUE AGENT

(71) Applicants: IURII USOV, Bucha (UA); YEVGEN LOPATIN, Kyiv (UA); DYMITR NOWICKI, Krakow (PL)

(72) Inventors: IURII USOV, Bucha (UA); YEVGEN LOPATIN, Kyiv (UA); DYMITR NOWICKI, Krakow (PL)

(21) Appl. No.: 17/402,538

(22) Filed: Aug. 14, 2021

Related U.S. Application Data
(60) Provisional application No. 63/065,939, filed on Aug. 14, 2020.

(51) Int. Cl. G06F 40/35; G06N 3/08

(52) U.S. Cl. CPC G06F 40/35; G06N 3/08

(57) ABSTRACT

A freeform multi-turn dialogue agent may be programmed to analyze user inputs and drive a dialogue with the user to an intent of the user. The agent does not assume any a priory intent of the user but develops concepts and intent from continued dialogue with the user. The agent analyzes user sentiment to develop the concept and intent and also clarifies any HyperPersonalized Meaning Words (also know as multi-meaning words or green words). The agent analyzes the concept, sentiment and HPWM and responsive to the analysis, performs one or more actions that drive the dialogue with the user to an intent of the user.

### CROSS REFERENCE TO RELATED APPLICATIONS

This application claims priority to U.S. Provisional Patent No. 63/065,939 filed 14 Aug. 2020, the entire contents of which are herein incorporated by reference.

### FIELD OF THE INVENTION

The present invention relates to a tool or agent for providing intelligent query processing and/or task completion.

### BACKGROUND OF THE INVENTION

There is a large family of intelligent agents that communicate with a user and maintain a conversation with him/her. Amongst such agents are the following types:

1. Chatbots whose primary purpose is to behave maximally like a person during a conversation, using jokes, slang, copying user speech style, answering general domain questions (e.g. “Tell me distance to moon”) or even tricky questions, in human nature

2.

Such agents are typically based on a simplified intent recognition, which try to match very complex initial ideas from user to very limited set of intents, using name-entity recognition algorithms, or to a bit wider but still very limited in capacity slot-filling to find previously defined parameters of user intent (like dates, location, hotel name, price, etc.) Using virtual agents has become very widespread across personal users and corporations, and help, for example, to manage service or support requests, reducing the need of personnel in service call centers, or use them as personal assistants to help with time-management tasks, information search in internet, book meeting, set up reminders in calendars, inform about upcoming events, book tables, dial contacts or write contacts simple messages and many more tasks. Typical benefits of using virtual agents may be time saving, reduction in actions a user has to take connected to simple tasks.

A problem with these types of dialogue agents is that they generally rely on the user having already formed their intent and/or made their decision, so they tend to take action in the minimum possible amount of moves. Such bots are not sufficiently free-form nor provide a sufficient human-like interaction.

However, prior art systems and virtual agent types do not have room to extract, store, analyze and accommodate real complexity of the user thoughts and feelings toward his/her situation, what the person tries to do and sees as best way forward and what is considered to be less desirable and what is unacceptable. Such complex thoughts in decision making can easily get to 700-1000 symbols, if measured by symbols count, rendering current systems simply unable to work with such a vast amount of information.

The prior art agents also do not clearly accommodate additional level of complexity connected to stages of human natural decision making, which can mean serious changes to user initial thoughts and feelings as he/she progresses through the process of making a decision and evaluating the options available.

Previous art do not address need to identify and clarify meaning of Hyper-Personalized Meaning Words (HPMW) which sound quite common (e.g. “good”, “bad”, “fun”, “cool”, “reasonable”, “fair”, “high-quality” to give a few), but exact meaning of which heavily depend on this user mindset, experience, context, and which require special meaning-discovery method.

Previous art to not accommodate, importance and role of well-formulated, well connected, timely questions, to help and foster decision-making is mostly omitted by previous art and virtual agents ask very few and usually quite simple questions

Previous art and virtual agents, may struggle to deal with multi-turn and multi-step decision-making processes, which may require several discovery dialogues, consisting of high-value questions, mixed with several round of search for information by agent and complex bargaining, negotiation and ordering actions in the end.

What is required is a system and method for providing enhanced agent functions, in particular in a multi-turn open dialogue scenario.

### SUMMARY OF ONE EMBODIMENT OF THE INVENTION

### Advantages of One or More Embodiments of the Present Invention

The various embodiments of the present invention may, but do not necessarily, achieve one or more of the following advantages:

provide an approach to navigating open multiturn dialogue, in order to extract full set of information (concept) from a user in connection with a given single decision-making cycle, while maintaining positive sentiment about conversation, and maximizing end decision value;

provide a method of setting up question-generator, based on deep reinforcement learning, which allow to train question-generator with comparatively small datasets in every given domain, saving computational resources.

improve discovery stage of dialogue, by asking user high-value questions, which steer dialogue, to help the user to progress with their decision making-process, while maintaining or creating positive sentiment of the user;

provide a system for managing clarification of meaning of Hyper-Personalized Meaning Words (HPM Words) which sound quite common (e.g. “good”, “bad”, “fun”, “cool”, “reasonable”, “fair”, “high-quality” to give a few), but exact meaning of which heavily depend on this user mindset, experience, context, and which require special meaning-discovery method.

These and other advantages may be realized by reference to the remaining portions of the specification, claims, and abstract.

### BRIEF DESCRIPTION OF ONE EMBODIMENT OF THE PRESENT INVENTION

In one aspect of the present invention, there is provided a free-form dialogue agent executable by at least one processor, the free-form dialogue agent programmed to analyze one or more inputs from a user for two or more of a concept, a sentiment, and multi-meaning words, and determine, responsive to the analysis, one or more actions that drive the dialogue with the user to a determined intent of the user.

In one aspect of the present invention, there is provided a method of providing a free-form dialogue with a user comprising providing one or more dialogue prompts to a user device of a user and receiving one or more dialogue inputs from the user via the user device. The inputs may be analyzed for two or more of a concept, a sentiment, and HPM words. Responsive to the analysis, one or more actions may be selected and performed that drive the dialogue with the user.

The above description sets forth, rather broadly, a summary of one embodiment of the present invention so that the detailed description that follows may be better understood and contributions of the present invention to the art may be better appreciated. Some of the embodiments of the present invention may not include all of the features or characteristics listed in the above summary. There are, of course, additional features of the invention that will be described below and will form the subject matter of claims. In this respect, before explaining at least one preferred embodiment of the invention in detail, it is to be understood that the invention is not limited in its application to the details of the construction and to the arrangement of the components set forth in the following description or as illustrated in the drawings. The invention is capable of other embodiments and of being practiced and carried out in various ways. Also, it is to be understood that the phraseology and terminology employed herein are for the purpose of description and should not be regarded as limiting.

### BRIEF DESCRIPTION OF THE DRAWINGS

FIG. 1 substantially depicts a schematic of a system for implement a free-form dialogue agent;

FIG. 2 substantially depicts a schematic of an embodiment of a multi-modal agent; and

FIG. 3 substantially depicts a scheme of a reinforced learning agent and its interaction with other models.

### DESCRIPTION OF CERTAIN EMBODIMENTS OF THE PRESENT INVENTION

In the following detailed description of the preferred embodiments, reference is made to the accompanying drawings, which form a part of this application. The drawings show, by way of illustration, specific embodiments in which the invention may be practiced. It is to be understood that other embodiments may be utilized and structural changes may be made without departing from the scope of the present invention.

There will be described herein a flexible human-like automatic agent that can assist the user in solving tasks. Examples of such an agent could be a seller agent, buyer agent, etc. The agent is made maximally close to human behavior, is able to make decisions in open space (so, decision space is not a priori limited), and can reach exterior sources of information such as catalogue, encyclopedia or knowledge base. The agent may also has its own “Theory of mind” that helps it to reflect the user.

The automatic agent uses generative transformer-based models to perform free-form dialogue that steers the user to the user's goal. The agent can be trained or fine tuned via reinforcement learning, and/or modify their output algorithmically to get the best answer. Most steering is done by asking questions to the user.

By contrast, typical prior art chatbots are based on decision trees which it must follow forming some kind of predefined scenario. State-of-the-art chatbots are either “small talk” bots that maintain free dialogue or goal-oriented ones. Existing goal-oriented bots are made under the assumption that the user already made the decision, so they tend to take action in the minimum possible amount of moves. On the contrary, the agent that will be described hereinbelow is designed to clarify user's vision and drive him/her through decision-making process. This agent does not always talk itself, rather asking questions to the user, and completing knowledge about the customer's case. The agent is not restricted to dialogue trees, frames, but can choose a strategy to get the best result based on the goal, concept and intent derived progressively from the user.

The whole dialogue is aimed at finding out (as deeply as possible) the details of the concept or intent of the user. To do this, there are several elements of the process. The first element is a special model for preparing and generating questions (using generative technologies and rf learning), which are aimed at clarifying the concept and clarifying the green words. At the same time, this model is aimed at maintaining a dialogue so that a person does not lose interest in communication and continues to give detailed answers.

An algorithm is used to manage the entire value creation dialogue. The model consists of various elements: The first element is a special machine that generates questions—a supervisor agent who makes a decision at any given time, analyzing:
concept progress;
sentiment;
the current content of the concept, the sufficiency of the concept;
clarity of HPM words;

Based on this analysis, the agent decides at any given time what actions are to be taken next:
ask the next question;
provide certain information;
seek and propose specific solutions;
give advice/answer to keep the conversation going;
clarify green words/the order.

The system is designed for various applications when understanding of customer's goals is needed. This includes, without limitation, choice of products or services, telemedicine, education, etc. The applications are primarily focused on the use cases when the customer has not yet made die decision about desired product or service. The system is dedicated to deep understanding of user's needs and guides the user step by step to die decision. The RL agent is trained to produce cues that help the user to become precise about their interests and show the solutions that might be optimal for the specific situation.

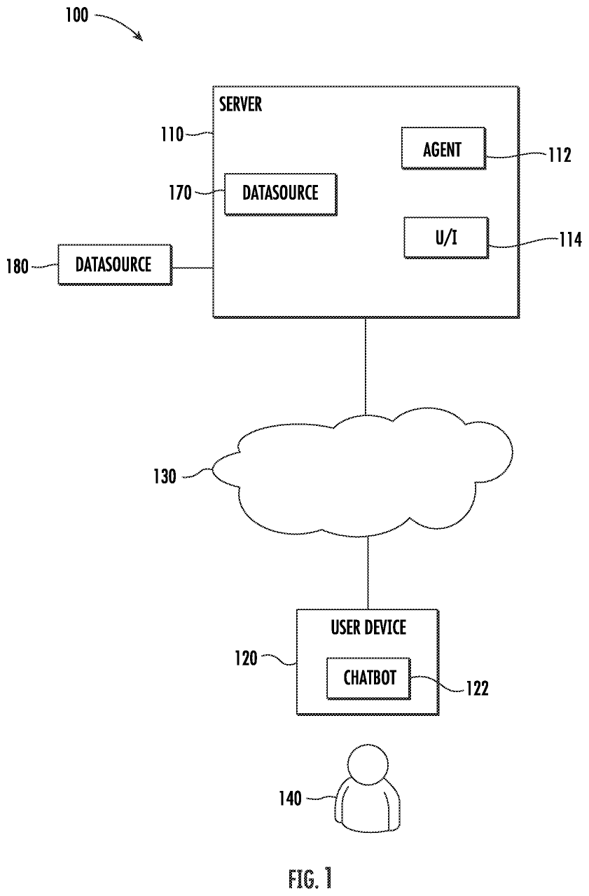

A system for implementing an intelligent agent is depicted in FIG. 1. The system 100 includes a server 110 that interfaces with a user device 120 through a communications network 130, such as a wide area network (Internet), or a local area network, a telephone network or any suitable network by which the user device 120 may interface with the server 110. In a particular embodiment. Typically, the service will include at least one processor and at least one operatively associated memory for executing one or more functions of the server 110. The server 110 may execute a user agent application 112. The server 110 may execute a user interface 114 for enabling the user device to communicate with the server 110 to receive inputs from the user device and to provide outputs to the user device. The user device 120 may execute a software application 122, such as a specific chatbot application, or a web browser application or similar for communication with the user interface of the server. The server 110 may include one or more internal data sources 170 that may store data related to customer queries for look up. The service 110 may also access one or more external data sources 180.

The system 100 is based on so called “concepts”—the user thoughts and feelings toward his/her situation, what the person tries to do and sees as best way forward and what is considered to be less desirable and what is unacceptable. Such complex thoughts in decision making can easily get to 700-1000 symbols,

The concepts are patterns that help to represent user's thinking with respect to the decision of choosing certain product/service or making the decision. The concepts enable to parameterize customer's motivation during interaction with the seller or other counteragent. User's Concept may include current thought of user in the domain, urgency, main drivers, trigger events, previous experiences, things to avoid, perceived risks, technical specs, brand preferences, any budgeting considerations, ordering constraints. etc. The concepts are visible to the system as some natural-language features of user's cues; they can be extracted with help of a neural network trained for this purpose.

Example of Concept:

User Concept:

“I'm looking for RPGs which give a lot of opportunities for building your character(s). One of my favorite parts of many games is simply building your character in different ways, and coming up with a lot of different ideas. Tactics based games have typically been the best, since I'm given the chance to build many different types of characters all at once, as well as the build of the team overall. I've played the usual Final Fantasy Tactics, disgaea, and a handful of the advancewars (haven't gotten around to fire emblem games though). Other games in general I've played which were really good for character building . . . Fallout 2 (and 3/NV), Mount and Blade, Dungeons of Dredmore, Space Pirates and Zombies (ship building instead), Elder Scrolls series, Jade Empire. If it is a AAA PC title released in the last 2-4 years, I probably know of it, so no need to suggest the obvious skyrim/diablo/fallout3/etc games. As for platforms, I have a PC, wii, DS, PSP.

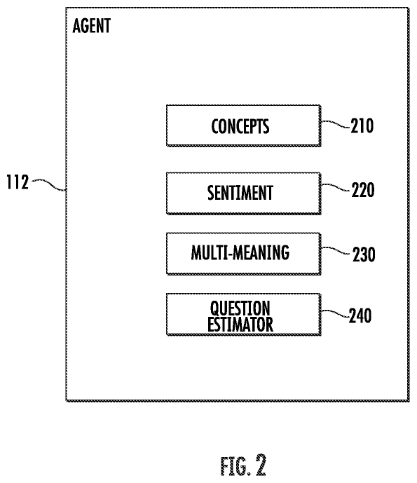

The user agent may be represented as executing a number of functionalities or modes. As shown in FIG. 2, the user agent 112, may include be a multi-modal system, with modes for concepts 210, sentiment 220, Hyper Personalized Meaning words 230.

By engaging the user through an application on the user device, an agent is able to conduct a free-form dialogue with a user 140 at the user device 120 to drive a conversation with a user to a user goal. The agent provides outputs to a user and receives inputs from the user via the communications network 130. The outputs are typically prompts. The outputs are typically spoken prompts but may be visual prompts, such as text prompts, video prompts

The user inputs are typically spoken prompts and undergo speech recognition processing in a speech recognition module to process the received input from speech into text. The text may then undergo natural language processing in a natural language processing module. These services may be performed with the server 110 or may be provided by remote services, including third party services.

Unlike task-completion agents, the user is not supposed to have a priory specified intent, the intelligent agent interacts with the user and assists in making decisions during the dialogue. The intent may be extracted from user's cues using a “customer vision” or “concept”. The customer vision may includes customers ideas in several dimensions—urgency, trigger, previous experience, what he wants to accomplish, fix, improve, positive references, negative references, tech specs, budget considerations, stage of the decision-making process, etc. For each customer vision, the system may measure the total score of vision clarity in total and in each dimension.

The agent may record a primary “customer vision” or concept. The system identifies the user at registration or login, then the system creates internal representation implicitly based on any dialogue history with the user. Thus the customer vision consists of an internal model's memory plus several categorical and numerical variables measured by classification/regression submodels. This way, the system may store current status of customer visions in different purchasing or problems (if the decision is not connected with any purchases). The system may then uncover “CV” with more details of intent by a set of relevant questions that prompt inputs from the user. The user inputs undergo multi-modal processing to determine concepts, sentiment and multi-meaning words. Where multi-meaning words are identified, the user may be prompted to clarify the meanings of such words.

The core of the system consists of neural-network NLP models including generative models such as transformer networks (and possibly Generative Adversarial Networks (GANs). Selective neural networks can choose best-values variant among fixed set of possible agent's cue. Both networks work in the interaction with value network then provides evaluation of agent's cues according to various criteria and then a best choice is made.

Concepts may be identified by the concept model 210 through a vectorization technique, such as term frequency inverse document frequency (tf-idf) vectorization, paragraph embeddings such as skip-thoughts, and T-SNE visualization techniques. The concept discovery model is a neural network taking to input the vector embeddings of user's cues. This model can measure “strength” of each concept in a specific cue and mark words or phrases related to it.

The sentiment model 220 may be programmed to use a special regression model based on the convolutional neural network and multi-layer perceptron (MLP) trained on the user inputs with sentiment labels. The sentiment analysis is used to provide feedback on user's satisfaction/dissatisfaction with agent's behavior; it forms one of the criteria used to compute the reward (as will be described below). The sentiment is measured using separate model, it is used both in training and in the inference mode of the agent. The sentiment helps to estimate user's satisfaction with the dialogue, it is combined with other evaluation criteria to form the value function. As a sentiment analysis model a feed forward network with 1D convolutions and fully connected layers may be used.

The multi-meaning model 230 may be programmed to identify Hyper Personanized Meaning words through Named Entity Recognition (NER) models trained for this purpose. Hyper Personanized Meaning words, including multi-sense an multi-definition words, are words that cannot be linguistically filtered out. It is important to indicate that this is not the category of words that are the same in spelling, but different in meaning. Multi-meaning words are words that have different meanings for different people. Examples of these words may include: good, bad, fun, cool, developed, beautiful, surprising. All comparative words give a very important signal during concept clarifications. The multi-meaning model is a specially trained model that reacts to such words. The model finds and ranks the importance of these multi-sense words that need to be clarified. After that, the model submits the problem to the algorithm for selecting questions of the dialogue machine to determine when it is necessary to clarify these words, what they mean, and what the person means by them at the moment.

Their meaning is then clarified by agent by asking user templated or Reinforce Learning (RL) generated questions that address phrases with HPM words. The NER model may be trained on examples of multi-meaning words labeled semi-automatically in real users' posts.

Question estimator model (for value network). The question estimator model 240 is a neural network that can evaluate agent's cues (specifically questions posed to the user but not limited to them) with various scales such as relevance to the user's input, connection with important parts of user motivation, insightfulness etc. This network is initially trained on the dataset of “user's post-question” pairs and it can be fine-tuned on the result of live interaction with the users.

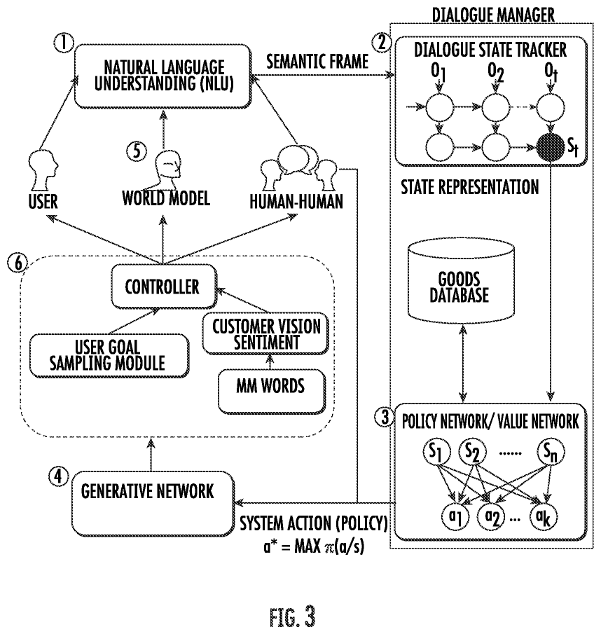

A reinforcement-learning (RL) agent uses information from the models listed above. An embodiment of a scheme of the RL agent and its interaction with other models is depicted in FIG. 3 which shows the process of interaction of the trainer RL agent with a user.

World Model is a vision of the world in particular domain (e.g. games, their properties, prices etc) Concept is discovered, and decision-making assistance is provided to the user
Steps O1, O2 . . . Ot, in FIG. 3 are the steps of the dialogue; they can be defined by consecutive user inputs. State T is internal state of the system, including discovered concept particles, the value of sentiment etc, at the time T. The core RL module 6 processes sentiment, MM words, and user goals.

The RL agent chooses appropriate action at every moment of time in order to maximize the value of user-agent interaction. The reinforcement-learning (RL) core agent is dedicated to make decisions in the multimodal system. It interacts with many other models that can measure the other party's sentiment, determine the concepts in (human) cues, look for multi-meaning (“green”) words etc.

The agent uses a generative NLP model (such as GPT-3, though other models may be apparent to the person skilled in the art) to maintain the free-form dialogue.

The agent operates in a potentially unlimited action space (variety of its cues) and uses a generative model (transformer) to make arbitrary cues from the communication history and context. The action space includes actions such as database lookup, asking questions to find out the concept etc. The value function of this agent (the reward) has components based on the following criteria:

for how long the user wants to continue interaction with the agent (premature
termination of the session gives negative reward)
how many of the concepts are filled based on the user's answers (percentage of concept clarified)
how many of multi-meaning “green” words were specified in the dialogue (percentage of “green” words explained).
how positive are user's answers according to sentiment-analysis module

Unlike prior art agents that are mostly oriented to the users that have already made the decision, the present agent uses a technique of deep understanding of user vision (based on concepts), and asks relevant information to the user to help them make a decision that is most satisfying. The agent uses reinforcement learning in two ways: first, to select the best appropriate cue (question) among possible ones, and secondly, to generate the cue using Transformer network (Transformer Reinforcement learning, TRL).

The Value network 3 (FIG. 3) is used to estimate the value function. It is trained on the human-rated cues and continues training in unsupervised mode. When trained, the Value network is used to train the main agent (which can be a Transformer model. Recurrent network or other NLP model) in “self-play” mode the agent is taught to respond to real-word utterances (post) in the selected domain, die posts are collected from real users, e.g. from forums. The value function is a superposition of different criteria of evaluation of system's cues including their addressing to various concepts, general quality and relevance criteria, as well as relation to the multi-meaning words in user inputs and user's sentiment. The sentiment is measured using separate model, it is used both in training and in the inference mode of the agent. The sentiment helps to estimate user's satisfaction with the dialogue it is combined with other evaluation criteria to form the value function.

The agent can be trained using some amount of human-to-human stories of interaction. Then, a user simulator may be created that behaves like a typical user. This “user bot” is used to train the main agent.

To enable the agent to work more precisely, a set of engineered question templates may be used, which allows the agent to ask more targeted questions. A custom-trained named entity recognition (NER) is used to find key entities in user's cues and substitute them into questions.

The action space of the agent will include following options:
Provide free-form generated cue (GPT or similar)
Provide modified generated cue (e.g. include entities)
Provide template question from discrete spectrum (with NER—recognized entities)
Search in the database using semantic search

The agent built on this technology is highly flexible, it has higher potential in assisting user to make decisions and maximize the outcome and satisfaction of the user.

A concept is a complex multi-component idea about the specific feeling of a person in exact area, what their current state is, whether they have any formed intention. If there is no intention, the agent helps the user develop the concept and intent. The agent can work with the user's concept in any stage at any stage of the development of that concept, e.g. when they are still at the top, or have not formed an exact intent, and so on.

A particular distinction of the agent of the present embodiments is that unlike prior art agents, the agent of the current embodiments does not try to categorize or frame or just fill the slots of intents. This means that the purpose of the dialogue is not to split every input of the user into slots. Instead, the goal of the dialogue is to fill a vector of the user's concept as much as possible in order to understand the user's feelings and desires, what they think about the current situation and what they would like to improve. In the concept there is a feeling gained from some event and reaction—to do something with it.

The concept is stored in the form of a vector, in order to form a dialogue machine that sets for itself the goal of understanding the concept of a person preserving it. The agent can then carry out a search that contains more than just simple search queries. This helps the agent to avoid transforming the intent into categorization, frames, and into some simple understandable search queries. By putting together a concept and forming this vector, with the goal to fill the vector, the user is more easily brought to a set of clear answers about they situation: e.g. what they are going to do, what they want to achieve, and so on.

An AI model may be provided to assess concept “total score” which indicates how far user has gone in his decision process, how full is concept by specifically scoring major decision making context fields:
major drive—fix problem, improve something working, get new emotions, etc
urgency
trigger events for this decision process
is there something to avoid
any references of what user wants to achieve
references of what to avoid
any brand/product preferences
any channel/place preferences
any technical specs to mention
any budget considerations
any timeline stated
who is the person to use what will be purchased
is there other people influencing this decision-making process.

All the above is intentionally not categorized too early and is store and analyzed as full open user generated text, which is put through score assessment model.

In order to measure concept score of fullness, system analyzes concept elements (Particles) which help to parametrize user's concept. For Concept Particle Discovery we use feed-forward networks (multi-layer perceptron MLP regression) in combination with TF-IDF or transformer-based text embeddings.

### Example 1

Current concept: “I want to play some kind of game like League of Legends, which are fun cooperatively local and have some nice character development. Any suggestions?” Concept particles (predicted by the Concept Particle Discovery model):

| Particle | P1 | P2 | P3 | P4 | P5 | P6 | P7 | P8 | P9 | P10 | P11 | Total |
|---|---|---|---|---|---|---|---|---|---|---|---|---|
| Predicted | 0.45 | 0.83 | 1.50 | 0.01 | 0.41 | 1.07 | 0.18 | 1.32 | 0.62 | 1.24 | 0.06 | 8.11 |
| Value | | | | | | | | | | | | |

Once Total score is calculated, it's fed into the agent to decide if the concept is clear enough to move to other stages, or more questions and more discovery needed.

In the example 1, total score of 8.11 represents 27% of average concept clarity, so agent will generate more questions.

### Example 2

User Input:
“I'm looking for RPGs which give a lot of opportunities for building your character(s). One of my favorite parts of many games is simply building your character in different ways, and coming up with a lot of different ideas. Tactics based games have typically been the best, since I'm given the chance to build many different types of characters all at once, as well as the build of the team overall. I've played the usual Final Fantasy Tactics, disgaea, and a handful of the advancewars (haven't gotten around to fire emblem games though). Other games in general I've played which were really good for character building . . . Fallout 2 (and 3/NV), Mount and Blade, Dungeons of Dredmore, Space Pirates and Zombies (ship building instead), Elder Scrolls series, Jade Empire. If it is a AAA PC title released in the last 2-4 years, I probably know of it, so no need to suggest the obvious skyrim/diablo/fallout3/etc games. As for platforms, I have a PC, wii, DS, PSP.”

Concept Particles (Predicted by the Model):

[96]

| Particle | P1 | P2 | P3 | P4 | P5 | P6 | P7 | P8 | P9 | P10 | P11 | Total |
|---|---|---|---|---|---|---|---|---|---|---|---|---|
| Value | 0.79 | 1.99 | 2.32 | 0.22 | 1.01 | 2.18 | 0.49 | 2.12 | 1.08 | 2.14 | 0.18 | 14.23 |

It is clear that in Example 2, the user has a more greatly developed concept or intent in regard to their communication with the agent. This score represents roughly 60% of concept clarity and fullness and is close to moving to the next step in dialogue. Thus, the total score is higher for Example 2 than for Example 1.

As a further example of a concept, an input may be:

[99] “When at home, me and my partner like to play games together, we'll mostly play League of Legends ORG side by side, but when we want to do something more just us we'll break out the Twilight WORK OF ART Struggle board or fire up Insect Armageddon. For work I often have to be on a boat and away from home for a period of time. The boat has internet, but it's too shitty to even handle the load of streaming video. I thought it would be nice if we could find a game that we could still play together while I way away from home (something turn based, or maybe even by email?), or even just something new that we could play when we are at home to help us spend more time focusing on each other. I'd love any suggestions for either. We're both very competitive, and will give something from any genre a chance (Board game suggestions are also totally on the table) EDIT: We also both have android phones, and I get a pretty decent signal on the boat, so that's an option as well.”

Based on the above input, Concept Vector is created, expanded during the dialogue and becomes input to the search management tool. The vector representation may consist of the N=4096 dimensions of the embedding vector.

For the text example above, the 4096-dimensional sparse vector has 46 non-zero values, as follows:
[0.12168102, 0.19105922, 0.06649226, 0.21166706, 0.42579617, 0.10602799, 0.10282669, 0.11123288, 0.14469288, 0.14119068, 0.14494019, 0.06123059, 0.05828408, 0.09808572, 0.13432685, 0.07088939, 0.34877154, 0.11527674, 0.14281966, 0.1217222, 0.12421358, 0.06386891, 0.15418557, 0.12704044, 0.09141828, 0.11521616, 0.05210408, 0.12295284, 0.11392576, 0.15061768, 0.13259812, 0.12299659, 0.18804404, 0.12615686, 0.11441498, 0.12143563, 0.27841219, 0.12677669, 0.11964387, 0.10906322, 0.12458813, 0.08281713, 0.07371893, 0.08212911, 0.06360502, 0.08568525]

By developing the concept through continued dialogue with the user, the final result of work of the dialogue part of the model is a special semantic vector—a set of query elements that contains a complete clarified concept, including references (negative, positive), a gradient of urgency and importance, and other characteristics. The resulting vector is an input for the implementation of the search and selection of the result.

The steps in building the system 100 are described briefly as follows

1. Building an interactive agent that maintains a free-form dialogue with a user.

2. Using Transformer type attention-based neural network to generate unrestricted answers for user's cues

3. Training the network with a large dataset of domain-specific dialogues.

4. Making embeddings for vectorization of user's cues (e.g. tf/idf vectorization)

5. Making a feed-forward network for classification of user's cues for parameters of her/his concern (so-called “concepts”)

6. Making a recurrent-network model for detecting user's sentiment: e.g. how the user is satisfied/unsatisfied with interaction with the agent.

7. Making a feed-forward neural network to detect multi-meaning (“green”) words. and then ask the user to specify the request, intent or concern behind them.

8. Making a semantic search engine for the external knowledge base to provide a description of solutions (e.g. goods or services) for a user.

9. Building a reinforcement-learning (RL) agent that uses information from the models listed above. It chooses appropriate action at every moment of time in order to maximize the value of user-agent interaction.

Advantages of the presently described free-form dialogue agent include that, unlike classical chatbots it is goal-oriented, so it helps the user to solve the problem(s) and that unlike task-completion agents, the user is not supposed to have a priory specified intent, the intelligent agent interacts with the user and assists in making decisions during the dialogue.

Additional advantages include:

1. The proposed agent provides unique support for a user in the case when he/she has no a priori specified intent. The continuous guidance in making a decision is provided.

2. The agent is more universal than existing task-completion bots, it provides a more pleasant experience for a user.

3. Accuracy of reproducing human assistant (seller, service person etc) is increased.

While specific discrete functionalities and modes are depicted herein for conveying the ideas performed by the present embodiments, the person skilled in the art will readily understand that the functionalities do not need to be discrete entities, discrete sections of code, nor be executed on discrete or separate hardware. Furthermore, the functionalities may not produce discrete identifiable outputs. Rather, agent software may execute within one or more processors to form an internal representation of the user's concerns determining “concepts” (what the user thinks about?), his/her “sentiment” (how the user is satisfied with interaction with the agent), and the multi-meaning (“green”) words asking the user to clarify what is behind such words in her/his speech. This internal representation, being a combination of two or more of concept, sentiment and multi-meaning words, can be used to generate actions that further the dialogue with the user to drive the user to their goal.

Many modifications and other implementations of the disclosure set forth herein will come to mind to one skilled in the art to which this disclosure pertains having the benefit of the teachings presented in the foregoing descriptions and the associated drawings. Therefore, it is to be understood that the disclosure is not to be limited to the specific implementations disclosed, and that modifications and other implementations are intended to be included within the scope of the appended claims. Moreover, although the foregoing descriptions and the associated drawings describe example implementations in the context of certain example combinations of elements and/or functions, it should be appreciated that different combinations of elements and/or functions may be provided by alternative implementations without departing from the scope of the appended claims. In this regard, for example, different combinations of elements and/or functions than those explicitly described above are also contemplated as may be set forth in some of the appended claims. Although specific terms are employed herein, they are used in a generic and descriptive sense only and not for purposes of limitation.

What is claimed is:

1. A free-form dialogue agent executable by at least one processor, the free-form dialogue agent programmed to analyze one or more inputs from a user for two or more of a concept, a sentiment, and multi-meaning words, and determine, responsive to the analysis, one or more actions that drive the dialogue with the user to an intent of the user.

2. The free-form dialogue of claim 1 programmed to analyze the one or more inputs for each of the concept, the sentiment, and multi-meaning words.

3. The free-form dialogue of claim 1 comprising a first model that is programmed to clarify the concept and clarify multi-meaning words using a dialogue with the user.

4. The free-form dialogue agent of claim 1 wherein the one or more actions comprise one or more of:
(A) ask a next question to the user;
(B) provide information to the user;
(C) seek and propose specific solutions;
(D) provide a response to keep the dialogue going;
(E) clarify multi-meaning words.

5. The free-form dialogue agent of claim 1 comprising a sentiment model programmed to determine a sentiment of a user input, wherein the sentiment model comprises a regression model trained on user inputs with sentiment labels.

6. The free-form dialogue agent of claim 1 comprising a question generator model comprising a neural network that can evaluate agent cues against one or more of relevance to a user input, connection with user motivation, insightfulness.

7. The free-form dialogue agent of claim 6 wherein the question generator model is trained on a dataset of user post/question pairs and live interaction with users.

8. The free-form dialogue agent of claim 1 programmed to execute a value function, wherein a reward of the value function is based on one or more of:
(A) how long the user wants to continue interaction with the agent;
(B) how many concepts are filled based on the user's answers;
(C) how many of multi-meaning words were clarified in the dialogue; and
(D) how positive a users answers were according to sentiment-analysis.

9. The free-form dialogue agent of claim 1 programmed to generate the one or more actions using Transformer Reinforcement learning.

10. A method of providing a free-form dialogue with a user comprising:
(A) providing one or more dialogue prompts to a user device of a user;
(B) receiving one or more dialogue inputs from the user via the user device;
(C) analyzing the one or more dialogue inputs from the user for two or more of a concept, a sentiment, and multi-meaning words;
(D) determining, responsive to the analyzing, one or more actions that drive the dialogue with the user.

11. The method of claim 10 comprising analyzing the one or more dialogue inputs for each of the concept, the sentiment, and multi-meaning words.

12. The method of claim 10 comprising clarifying the concept multi-meaning words using a dialogue with the user.

13. The method of claim 10 wherein the one or more actions comprise one or more of:
(A) asking a next question to the user;
(B) providing information to the user;
(C) seeking and proposing specific solutions;
(D) providing a response to keep the dialogue going;
(E) clarifying multi-meaning words.

14. The method of claim 10 comprising determining by a sentiment model a sentiment of a user input, wherein the sentiment model comprises a regression model trained on user inputs with sentiment labels.

15. The method of claim 10 comprising evaluating, by a question generator model comprising a neural network, agent cues against one or more of relevance to a user input, connection with user motivation, insightfulness.

16. The method of claim 15 wherein the question generator model is trained on a dataset of user post/question pairs and live interaction with users.

17. The method of claim 10 comprising executing a value function, wherein a reward of the value function is based on one or more of:
(A) how long the user wants to continue interaction with the agent;
(B) how many concepts are filled based on the user's answers;
(C) how many of multi-meaning words were clarified in the dialogue; and
(D) how positive a users answers were according to sentiment-analysis.

18. The method of claim 10 comprising generating the one or more actions using Transformer Reinforcement learning.
